(19) United States
(12) Patent Application Publication
(10) Pub. No.: US 2013/0297202 A1
(43) Pub. Date: Nov. 7, 2013

(54) INFORMATION PRESENTATION DEVICE AND NAVIGATION DEVICE

(71) Applicants: Satoshi Tamiya, Tokyo (JP); Yasuhiro Monde, Tokyo (JP); Masahito Matsumoto, Kobe-shi (JP); Makoto Oi, Kobe-shi (JP)

(72) Inventors: Satoshi Tamiya, Tokyo (JP); Yasuhiro Monde, Tokyo (JP); Masahito Matsumoto, Kobe-shi (JP); Makoto Oi, Kobe-shi (JP)

(73) Assignee: MITSUBISHI ELECTRIC CORPORATION, Tokyo (JP)

(21) Appl. No.: 13/979,515

(22) PCT Filed: Mar. 30, 2011
(86) PCT No.: PCT/JP2011/001914

§ 371 Date: Jul. 12, 2013

(51) Int. Cl. G01C 21/36

(52) U.S. Cl. CPC G01C 21/3679
USPC 701/430; 701/516

(57) ABSTRACT

There is provided a device that receives a broadcast providing a data distribution service from a broadcast station, registers data related to facilities acquired through the data distribution service in a primary database, extracts from the primary database data related to facilities near the position of the host vehicle every time a host vehicle has run a predetermined distance, registers the extracted data in a secondary database, and presents data for presentation extracted from the secondary database to a user.

### TECHNICAL FIELD

The present invention relates to an information presentation device for presenting information related to the area around a host-vehicle position to a user, and a navigation device using the same.

### BACKGROUND ART

Recently, data distribution services for users who use in-vehicle devices have been started in digital radio broadcasting, and in-vehicle devices interface with such services have also been put on sale.

In the conventional art, Patent Document 1 discloses a system for providing data distribution services. In this system, a receiver of an in-vehicle device receives a broadcast providing a data distribution service from a broadcast station, and acquires information related to, for example, gas stations to store the acquired information in a database. The information stored in the database is updated every time the receiver receives the broadcast providing the data distribution service.

Further, the in-vehicle device identifies a latitude and longitude of each gas station based on the information related to gas stations stored in the database, and calculates a distance from the host-vehicle position to each gas station using the latitude and longitude of the station concerned and the latitude and longitude of the host-vehicle position detected by a position detection unit.

Then, the in-vehicle device extracts information on a predetermined number of gas stations near the host-vehicle position from the database, and displays the extracted information in the form of list on the monitor.

Further, Patent Document 2 disclose a map display device that retrieves a plurality of pieces of information on the facilities near the host-vehicle position from among the information on facilities stored in the database, and the retrieved pieces of facility information are displayed in the form of list in order of distance from the host-vehicle position on a display device.

### PRIOR ART DOCUMENTS

### Patent Documents

Patent Document 1: United States Patent Application Publication No. 2010/0106514
Patent Document 2: Japanese Patent Application Publication No. 2001-174273

### SUMMARY OF THE INVENTION

### Problems to be Solved by the Invention

In the conventional art represented by Patent Document 1 and Patent Document 2, when a display-request operation of information related to the area around the host-vehicle position is made to the in-vehicle device, calculations and retrievals of respective distances to the host-vehicle position are performed using the database storing a huge volume of information obtained from the data distribution service, and then information on a predetermined number of facilities near the host-vehicle position is extracted from the database. Thus, this method takes a long time until the information on facilities are actually displayed after the display-request operation is made, causing a problem that the display response is slow.

This invention has been made to solve the problem above, and an object thereof is to provide an information presentation device capable of improving its response in presenting information stored in a database, and a navigation device using the same.

### Means for Solving the Problems

An aspect of the information presentation device according to the present invention comprises: a receiving unit for acquiring data related to facilities by receiving a broadcast providing a data distribution service from a broadcast station; a primary database storing unit for storing a primary database in which the data acquired by the receiving unit are registered; a database update processing unit for updating content in the primary database with data acquired by the receiving unit every time the receiving unit acquires data; a travel distance detection unit for detecting that the movable entity has traveled a predetermined distance; a position detection unit for detecting a position of the movable entity; a secondary-data extraction processing unit for extracting, from the primary database, data related to facilities near the position of the movable entity detected by the position detection unit at each time point when the travel distance detection unit detects that the movable entity has traveled the predetermined distance; a secondary database storing unit for storing a secondary database in which the data extracted by the secondary-data extraction processing unit are registered; a presentation-data extraction processing unit for extracting data for presentation from the data registered in the secondary database; and a presentation unit for presenting the data extracted by the presentation-data extraction processing unit to a user.

### Effect of the Invention

According to the invention, the response in presenting information stored in the database is improved.

### BRIEF DESCRIPTION OF THE DRAWINGS

FIG. 1 is a block diagram showing a configuration of an in-vehicle information presentation device according to Embodiment 1 of the invention.

FIG. 2 is a flowchart showing a secondary-data extraction process in Embodiment 1.

FIG. 3 is a timing chart of processing performed by the in-vehicle information presentation device of Embodiment 1.

FIG. 4 is a diagram illustrating an example of a screen that displays a station list.

FIG. 5 is a block diagram showing a configuration of an in-vehicle information presentation device according to Embodiment 2 of the invention.

FIGS. 6(a)-6(c) are flowcharts each showing a secondary-data extraction process in Embodiment 2.

FIG. 7 is a block diagram showing a configuration of an in-vehicle information presentation device according to Embodiment 3 of the invention.

FIG. 8 is a flowchart showing a secondary-data extraction process in Embodiment 3.

FIG. 9 is a block diagram showing a configuration of a navigation device according to Embodiment 4 of the invention.

FIG. 10 is a flowchart showing a secondary-data extraction process in Embodiment 4.

FIG. 11 is a diagram illustrating a definition of distance between a route and a station.

FIG. 12 is a diagram showing schematically an extraction area of secondary data by the navigation device of Embodiment 4.

FIG. 13 is a diagram for illustrating a benefit by extracting station-related data near a route.

FIG. 14 a block diagram showing a configuration of an in-vehicle information presentation device according to Embodiment 5 of the invention.

FIG. 15 is a flowchart showing a secondary-data extraction process in Embodiment 5.

FIG. 16 is a flowchart showing a presentation-data extraction process in Embodiment 5.

FIG. 17 is a block diagram showing a configuration of an in-vehicle information presentation device according to Embodiment 6 of the invention.

FIG. 18 is a flowchart showing an unnecessary data deleting process in Embodiment 6.

### MODES FOR CARRYING OUT THE INVENTION

Hereinafter, for the purposes of illustrating the invention in more detail, embodiments for carrying out the invention will be described with reference to the accompanying drawings.

### Embodiment 1

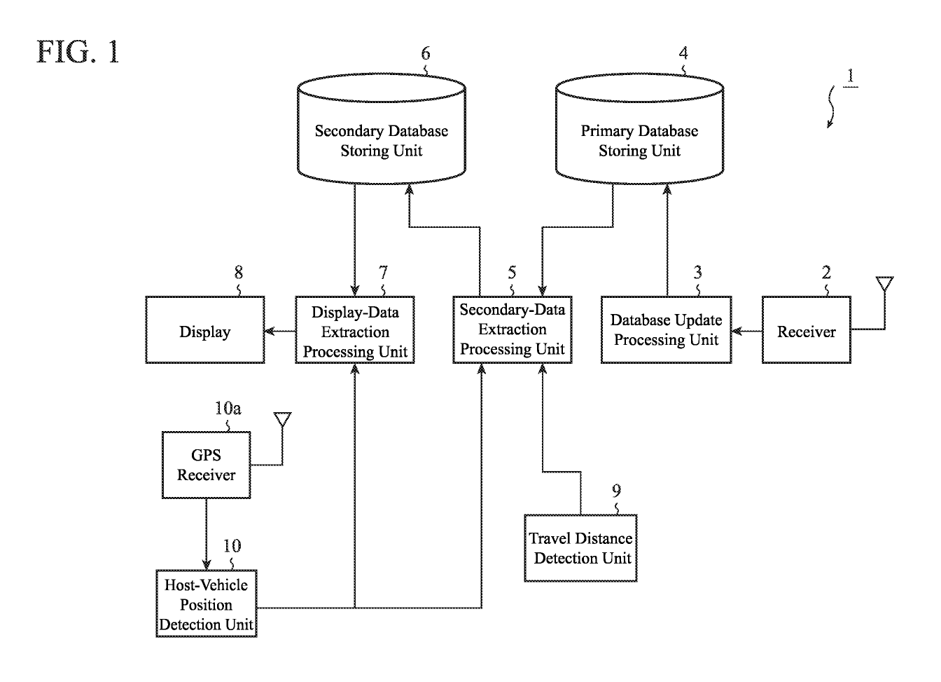

FIG. 1 is a block diagram showing a configuration of an in-vehicle information presentation device installed in a movable entity (moving object) (for example, a vehicle) according to Embodiment 1 of the invention. In FIG. 1, the in-vehicle information presentation device 1 of Embodiment 1, which is an information presentation device for presenting to a user data distributed from a service provider, includes a receiver 2, a database update processing unit 3, a primary database storing unit 4, a secondary-data extraction processing unit 5, a secondary database storing unit 6, a display-data extraction processing unit 7, a display 8, a travel distance detection unit 9, a host-vehicle position detection unit 10 and a GPS(Global Positioning System) receiver 10a.

The receiver 2 receives broadcasts providing data distribution services from broadcast stations and converts them to digital data processable by the database update processing unit 3.

The database update processing unit 3 updates content of a primary database, and the primary database storing unit 4 stores the primary database.

In the primary database data distributed by the data distribution services and received by the receiver 2 are registered. For example, in the case of receiving a data distribution service related to fuel stations for vehicle such as a gas station, data of (a) station name, (b) latitude and longitude of the station, (c) type and brand of fuel available in the station, (d) fuel price and the like, are distributed as the station-related data items and stored in the primary database. With respect to the data distribution service operated in the Unites States, where data related to fuel stations are stored in the primary database, since all of the fuel stations existing in vehicle-movable areas are identified, tens to hundreds of thousands data are stored in the primary database.

The secondary-data extraction processing unit 5 extracts from the primary database, every time the host vehicle is detected to have traveled a predetermined distance, data for a predetermined number of facilities around the position of the host vehicle detected by the host-vehicle position detection unit 10, to store the data in a secondary database. The secondary database storing unit 6 stores the secondary database, to which a memory device accessible at a higher speed than the primary database storing unit 4 is applied. The content stored in the secondary database is updated by the secondary-data extraction processing unit 5 every time the host vehicle has run the predetermined distance. For example, in the case of receiving the data distribution service related to fuel stations such as a gas station, data for a predetermined number of gas stations near the host vehicle are stored in the secondary database, and its content is updated every time the host vehicle has traveled the predetermined distance.

The display-data extraction processing unit 7 sorts in order of distance from the host-vehicle position, the data for facilities located around the host-vehicle position and registered in the secondary database, to extract a predetermined number of higher-order (shorter in distance) data from the secondary database. For example, in the case of receiving the data distribution service related to fuel stations such as a gas station, a predetermined number of data related to stations are extracted as presentation data in ascending order of distance from the host vehicle (closest to furthest). The display 8 is a display monitor for displaying maps or the like, and realized by an LCD monitor or the like. For example, in the case of receiving the data distribution service related to fuel stations, the predetermined number of stations are displayed on the display 8 in the form of list in ascending order of distance from the host vehicle.

The travel distance detection unit 9 successively detects a travel distance of the host vehicle and also detects that the movable entity has traveled a predetermined distance. It starts detecting a travel distance of the host vehicle each time when the secondary data are extracted by the secondary-data extraction processing unit 5 from the primary database, and notifies the detected travel distance to the secondary-data extraction processing unit 5.

The host-vehicle position detection unit 10 detects the position of the movable entity, and successively calculates latitudes and longitudes of the host-vehicle position using location information acquired through the GPS receiver 10a. These pieces of information on the host-vehicle position are successively supplied to the secondary-data extraction processing unit 5 and the display-data extraction processing unit 7. The GPS receiver 10a receives the location information on the host vehicle from the GPS satellites.

Next, the operation will be described.

### (1) Update Processing of Primary Database

Firstly, the receiver 2 receives a broadcast related to the data distribution service from the service provider. Here, description will be made according to a case of receiving the data distribution service related to fuel stations as an example. The receiver 2 converts service data extracted from the received broadcast-data to digital data processable by the database update processing unit 3, to output them to the database update processing unit 3. For example, here it is assumed that data of (a) station name, (b) latitude and longitude of the station, (c) type and brand of fuel available in the station, and (d) fuel price are obtained as the station-related data items.

The database update processing unit 3 updates the content in the primary database stored in the primary database storing unit 4 using the data input from the receiver 2. Among the data items described above, (a) station name, (b) latitude and longitude of the station, and (c) type and brand of fuel available in the station are static data that are not frequently updated, whereas (d) fuel price fluctuates frequently. Accordingly, in the primary database, the fuel price of each station is frequently updated. Of course, when information related to any one of the data items (a) through (d) has altered or when a station is newly established or closed, data concerned are updated accordingly.

It is noted that the receiver 2 receives a broadcast related to a data distribution service at a predetermined frequency (for example, per several hours), and the database update processing unit 3 updates the primary database, accordingly. In this way, the content of data in the primary database is always kept up-to-date.

### (2) Update Process of Secondary Database

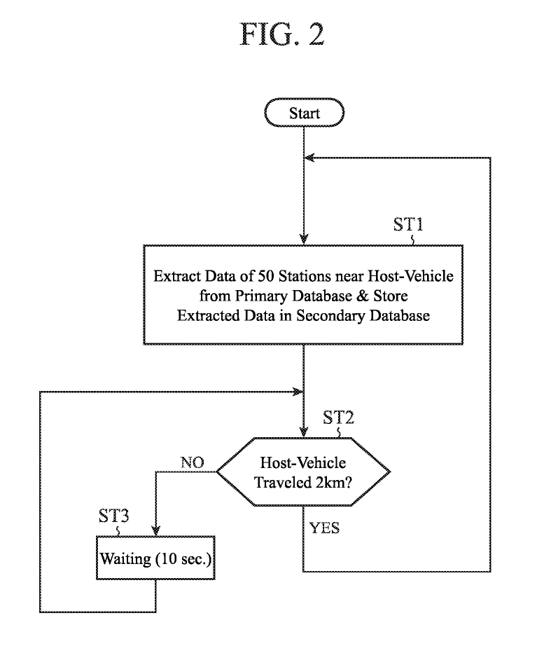

FIG. 2 is a flowchart showing a secondary-data extraction process in Embodiment 1, and the details of this secondary-data extraction process by the secondary-data extraction processing unit 5 will be described according to FIG. 2.

The secondary-data extraction processing unit 5 accepts inputs from the host-vehicle position detection unit 10 about information on the host-vehicle position detected by the unit 10, extracts from the primary database a predetermined number of data (for example, 50 data) related to stations near the host-vehicle position, and registers these data in the secondary database (Step ST1).

For example, the secondary-data extraction processing unit 5 calculates a distance between the position of a station defined under the station-related data item “latitude and longitude of the station” and the current host-vehicle position (latitude and longitude) detected by the host-vehicle position detection unit 10, and compares the distance with a predetermined threshold value to determine whether or not the station is near the host-vehicle position.

Note that, taking into consideration the position measurement accuracy of the GPS system, this threshold value may include a tolerance margin to determine that stations within a range of distance corresponding to the tolerance margin are near the host-vehicle. Alternatively, all of the data that relate to stations located within a predetermined distance from the host-vehicle may be extracted.

This makes it possible to extract appropriate number of data of stations from a close-packed area where a large number of stations exist within an area around the host-vehicle position. Further, as the value of the predetermined number above, the maximum number among the numbers of stations which have been determined to be near the host-vehicle in the areas where the host vehicle has traveled in the past may be used.

Then, based on a travel distance of the host vehicle detected by the travel distance detection unit 9, the secondary-data extraction processing unit 5 determines whether or not the host vehicle has run a predetermined distance (for example, 2 km) from the time point when the data were previously extracted from the primary database and stored in the secondary database (Step ST2). When it is determined that the host vehicle has run the predetermined distance (Step ST2; “YES”), the secondary-data extraction processing unit 5 returns its process to Step ST1 to pick up from the primary database the data related to the predetermined number of stations near the host-vehicle position at that time, and stores the data in the secondary database.

In contrast, when it is determined that the host vehicle has not run the predetermined distance (Step ST2; “NO”), the secondary-data extraction processing unit 5 waits for a preset time period (for example, 10 seconds) (Step ST3), and then returns its process to Step ST2 to repeat the process aforementioned. As a result, every time the host vehicle has moved 2 kilometers, the data content in the secondary database are updated and the data related to the predetermined number of the stations around the host vehicle are stored therein.

It is noted that the data extraction processing by the secondary-data extraction processing unit 5 is performed, not when the user makes an instruction to display a station list, but automatically every time the host vehicle has moved 2 kilometers.

### (3) Presentation of Service Data

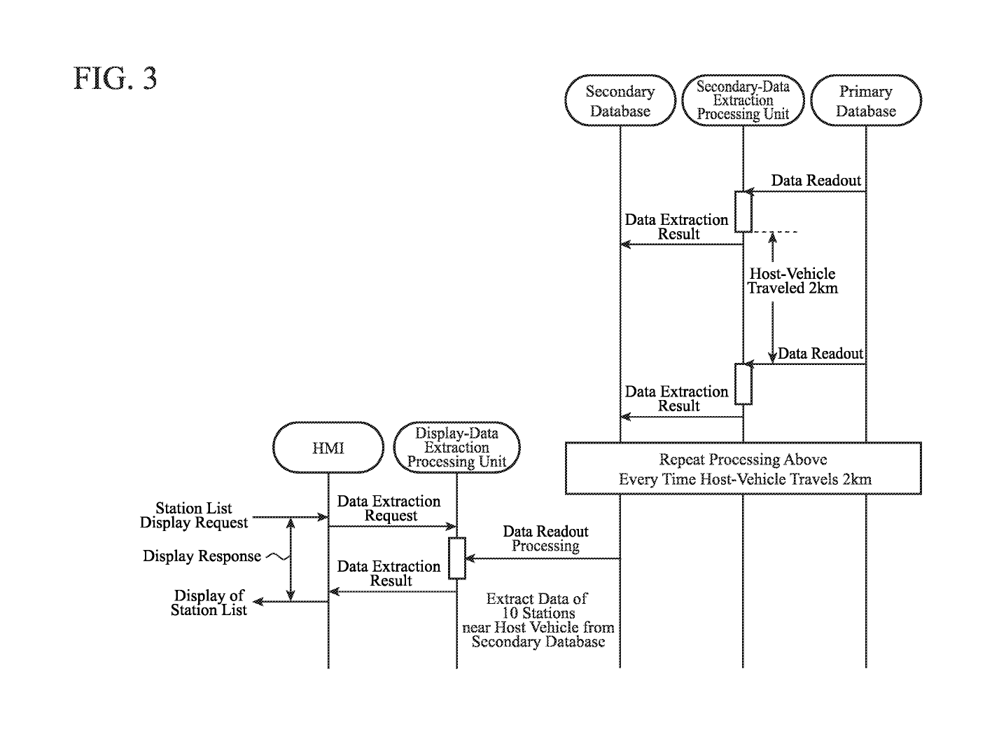

FIG. 3 is a timing chart of processes performed by the in-vehicle information presentation device of Embodiment 1. The execution timing shown in the timing chart of the secondary database update process, which is illustrated in the right area in FIG. 3, is the same as that of the process described in the preceding section (2). The display-data extraction processing unit 7 and the display 8 serve to provide an HMI (Human Machine Interface) for displaying a setting screen that is used to set various types of information and for receiving an external setting operation via one or more input devices.

In the timing chart illustrated in the left area in FIG. 3, using an input device through the setting screen, the user requests that a station-list be displayed. When the station-list display request is established, the input device makes a data extraction request to the display-data extraction unit 7 to extract data according to the station-list display request.

Upon receiving the data extraction request, the display-data extraction processing unit 7 accesses the secondary database storing unit 6 and sorts the data stored in the secondary database in order of distance from the current host-vehicle position detected by the host-vehicle detection unit 10, to extract a predetermined number of data (for example 10 data) with higher-order and closer distance from the secondary database. Note that the predetermined number subject to the extraction from secondary database is equal to the number of the stations to be indicated in the station list.

The data extracted by the display-data extraction processing unit 7 are displayed as the station list on the display 8. This makes it possible for the user to refer to data related to the stations around the host-vehicle position using the station list displayed on the display 8.

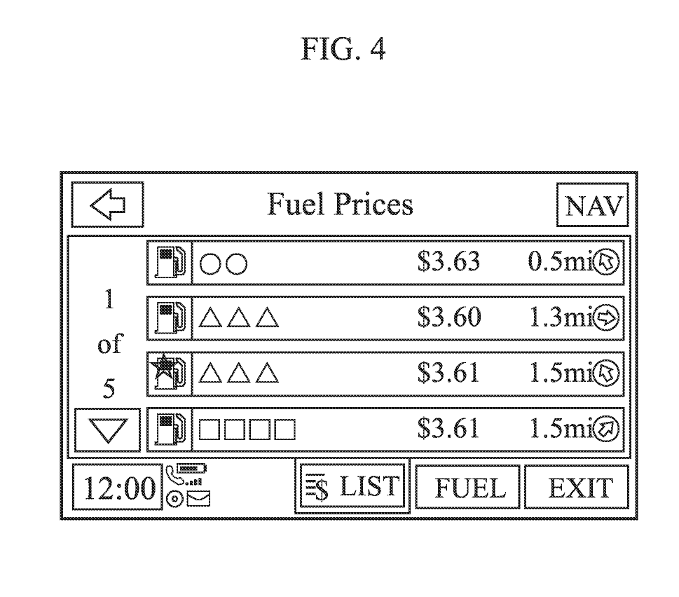

FIG. 4 is a diagram showing an example of a screen displaying a station list. The station list shown in FIG. 4 is a list of fuel stations (for example, gas stations) located around the host-vehicle. The list includes, per each station, station name, a kind (brand) and price of fuel supplied, and a distance and direction from the vehicle.

The screen shown in FIG. 4 is referred to by the user in choosing a station for fueling the host vehicle, and thus the predetermined number of nearby stations from the host-vehicle position are indicated therein.

It is noted that, when the information presentation device is used as navigation device, on the display 8, displayed in normal use is, for example, a map display screen by navigation process, information on the song played through the car-audio (song name, artist name, etc.), or the like. Therefore, when the user wishes to refer to the station list, he/she needs to change the displayed screen using the input device. Upon completion of the display-screen changing operation, the display-data extraction processing unit 7 calls the station list and displays it on the display 8.

As described above, according to Embodiment 1, it includes: the receiver 2 for receiving broadcasts related to a data distribution service from a broadcast station, to acquire data related to facilities as information service objects by the data distribution service; the primary database storing unit 4 for storing a primary database in which the data acquired by the receiver 2 are recorded; the database update processing unit 3 for updating contents of the primary database at every time the receiver 2 acquires the data using this data acquired by the receiver 2; the travel distance detection unit 9 for detecting a travel distance of the host vehicle; the host-vehicle position detection unit 10 for detecting a position of the host vehicle; the secondary-data extraction processing unit 5 for extracting from the primary database, at every time the host vehicle is detected to have run a predetermined distance, data related to facilities existing around the host-vehicle position detected by the host-vehicle position detection unit 10 at that time; the secondary database storing unit 6 for storing the secondary database in which the data extracted by the secondary-data extraction processing unit 5 are recorded; the display-data extraction processing unit 7 for extracting data for display from the data recorded in the secondary database; and the display 8 for displaying the data extracted by the display-data extraction processing unit 7 to present it to a user.

Thus, from among the data registered in the primary database, data related to facilities located around the host-vehicle position are extracted in advance and registered in the secondary database, and when a data display request is made, data extracted from among the data in the secondary database are displayed. This improves the display response to data display requests. That is, the display response time before actually displaying the requested data is shortened.

In the above Embodiment 1, a case of receiving the data distribution service related to fuel stations is described as an example; however, the data distribution service applicable to the invention is not limited thereto. The invention is applicable to any data distribution services as long as they provide service data describing position information on facilities (a position or an area where a facility is located). The secondary-data extraction processing unit determines whether or not each facility is located around the host-vehicle position using the position information described in the service data.

Further, in the above Embodiment 1, the case is described where the secondary-data extraction processing unit 5 extracts from the primary database, every time the host vehicle is detected to have run the predetermined distance, data related to the area around the host-vehicle position, to store the data in the secondary database; however, the invention is not limited to this case. For example, means for measuring a period of running time of the host vehicle may be provided, allowing the data to be extracted from the primary database and stored in the secondary database every time a predetermined running time has elapsed. Further, on the display 8 may be provided a screen for accepting user inputs on the above-mentioned predetermined distance or running time through an input device (not shown) in order that the secondary-data extraction processing unit 5 can extract data on the basis of values set by the user.

### Embodiment 2

In the above Embodiment 1, there is shown the in-vehicle information presentation device 1 which is configured to receive a single kind of data distribution service to present data related to, for example, fuel stations. In contrast, in Embodiment 2, an in-vehicle information presentation device will be described which is configured to present data related to several kinds of facilities provided by data distribution services. Practically, in many cases, such a configuration is applied that is capable of presenting to a user data distributed by distribution services related to several kinds of facilities.

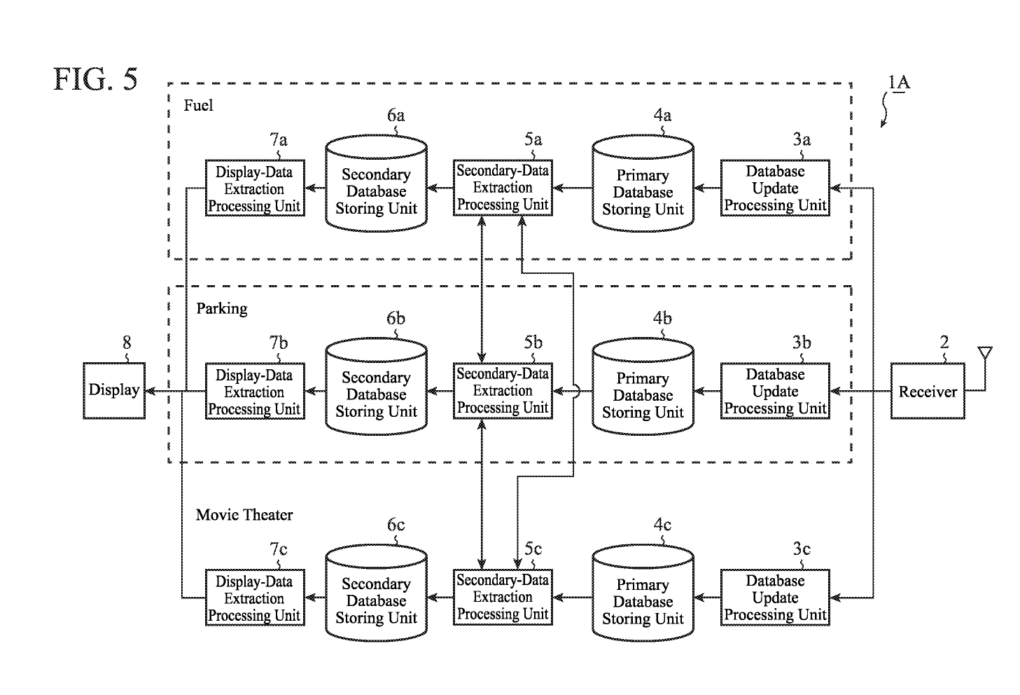

FIG. 5 is a block diagram showing a configuration of the in-vehicle information presentation device according to Embodiment 2 of the invention. In FIG. 5, the in-vehicle information presentation device 1A of Embodiment 2 is configured to include parts each corresponding to one kind of data distributed by one or more service providers. It is noted that a travel distance detection unit 9, a host-vehicle position detection unit 10 and a GPS receiver 10a are omitted from the illustration. Further, in FIG. 5, the same reference numerals are used to indicate the same units as those in FIG. 1, so that redundant illustrations are omitted here.

In the case shown in FIG. 5, the in-vehicle information presentation device 1A is configured to receive data distribution services related to three kinds of facilities: “fuel”, “parking” and “theater”.

“Fuel” data are data related to vehicle-fuel stations, which contain at least data related to positions of the stations. Data related to fuel prices and the like may be contained therein.

“Parking” data are data related to parking places, which contain at least data related to positions of the parking places. Data related to their capacity and/or availability may be contained therein.

“Movie Theater” data are data related to movie theaters, which contain at least positions of the movie theaters. Data related to movies being played, movies scheduled to be played and/or screen time of movies may be contained therein.

The in-vehicle information presentation device 1A includes, as a part corresponding to “fuel” data, a database update processing unit 3a, a primary database storing unit 4a, a secondary-data extraction processing unit 5a, a secondary database storing unit 6a, and a display-data extraction processing unit 7a.

Also, the in-vehicle information presentation device 1A includes, as a part corresponding to “parking” data, a database update processing unit 3b, a primary database storing unit 4b, a secondary-data extraction processing unit 5b, a secondary database storing unit 6b, and a display-data extraction processing unit 7b.

Further, the on-vehicle information presentation device 1A includes, as a part corresponding to “movie theater” data, a database update processing unit 3c, a primary database storing unit 4c, a secondary-data extraction processing unit 5c, a secondary database storing unit 6c, and a display-data extraction processing unit 7c.

It should be noted that, into each secondary-data extraction processing unit (5a-5c), travel distances of the host-vehicle detected by the travel distance detection unit 9 are successively input, which is omitted from illustration in FIG. 5. Further, into each secondary-data extraction processing unit (5a-5c) and each display-data extraction processing units (7a-7c), host-vehicle positions detected by the host-vehicle position detection unit 10 are successively input, which is omitted from illustration in FIG. 5. With this configuration, the secondary-data extraction processing units 5a-5c and the display-data extraction processing units 7a-7c operate in a similar way to that in the configuration according to Embodiment 1 explained with reference to FIG. 1.

In the in-vehicle information presentation device 1A, priorities are assigned according to the kinds of data distributed by data distribution services. In this embodiment, priorities are given in an order of “fuel”>“parking”>“movie theater”. Priorities may be fixed according to the kinds of data or may be set by the user.

Further, the secondary-data extraction processing units 5a-5c are configured to mutually monitor their operation states, whereby each unit 5a-5c operates according to the priority assigned to the kind of data each unit handles.

Namely, among the secondary-data extraction processing units 5a-5c, when one of them handling higher priority data is operating, the other unit (s) suspends its operation and waits until the unit handling the higher priority data completes its operation. This avoids a situation where: the process load on the processor of a computer serving as the in-vehicle information presentation device 1A becomes too high because of congestion in operations of the secondary-data extraction processing units, processes are concentrated on reading out from storages storing the databases, and operation for processes other than the data distribution service are delayed.

Next, the operation will be described.

This Embodiment 2 is characterized in that each secondary-data extraction processing unit operates according to the priority assigned to the kind of data each unit handles. Therefore, the description will be made mainly for the process extracting data from the primary database to the secondary database. Further, it is assumed that each database update processing unit 3a-3c update the corresponding primary databases stored in the primary database storing units 4a-4c using the corresponding kinds of data received by the receiver 2.

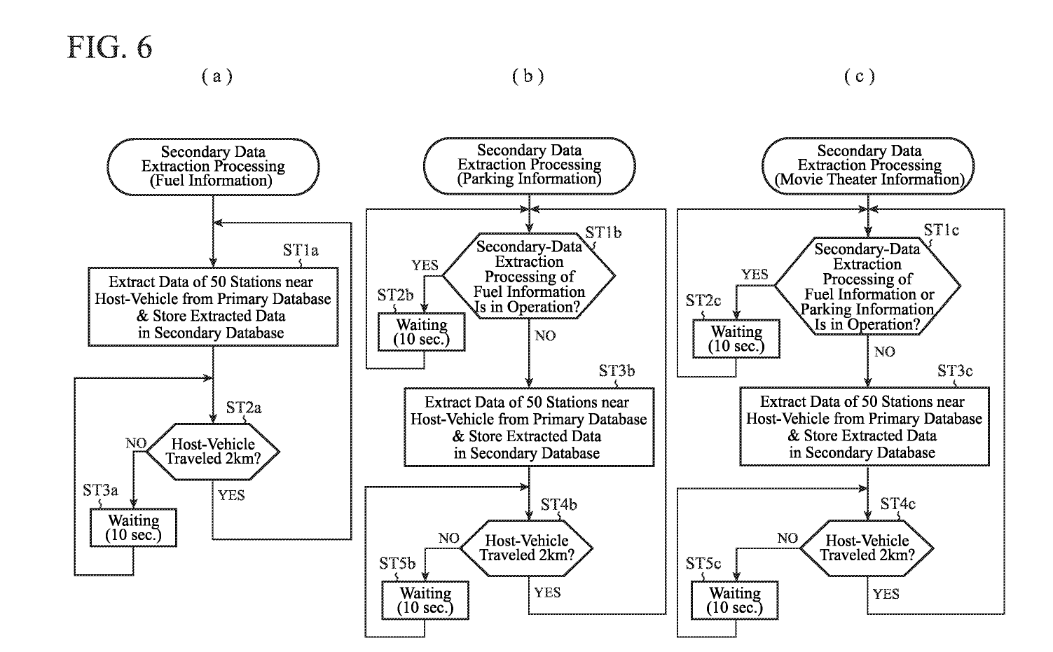

FIGS. 6(a)-6(c) shows flowcharts showing secondary-data extraction processes in Embodiment 2, which illustrates operations of the secondary-data extraction processing units according to the priority order of “fuel”>“parking”>“movie theater”. As shown in FIG. 6(a), the secondary-data extraction processing unit 5a accepts inputs on the host-vehicle position detected by the host-vehicle position detection unit 10, extracts from “fuel” data of the primary database stored in the primary database storing unit 4a a predetermined number of data determined to be relating to the area around the host-vehicle position, and registers these data in the secondary database in the secondary database storing unit 6a (Step ST1a).

It is noted that the “fuel” data determined to be related to the area around the host-vehicle position are the data which fuel stations near the host-vehicle position are associated with. Determination on whether or not a fuel station is near the host-vehicle position is made in a similar manner to that in the Embodiment 1 above. That is, it is determined by first calculating a difference in distance between the position of the fuel station (latitude and longitude) and the current host-vehicle position (latitude and longitude) detected by the host-vehicle position detection unit 10 and then comparing the difference in distance to a predetermined threshold value.

Then, based on a travel distance of the host vehicle detected by the travel distance detection unit 9, the secondary-data extraction processing unit 5a determines whether or not the host vehicle has run a predetermined distance (for example, 2 km) from the time point when the data were extracted from the primary database and stored in the secondary database previously (Step ST2a). When it is determined that the host vehicle has run the predetermined distance (Step ST2a; “YES”), the secondary-data extraction processing unit 5a returns its process to Step STla to retrieve from the primary database a predetermined number of “fuel” data (for example, 50 data) of the stations near the host-vehicle position at that time, and stores the retrieved data in the secondary database.

When it is determined that the host vehicle has not run the predetermined distance (Step ST2a; “NO”), the secondary-data extraction processing unit 5a waits for a preset time period (for example, 10 seconds) (Step ST3a), and then returns its process to Step ST2a to repeat the process aforementioned. As a result, every time the host vehicle has traveled 2 kilometers, the data content in the secondary database are updated and the data related to the predetermined number of the stations around the host vehicle are stored therein.

As shown in FIG. 6(b), the secondary-data extraction processing unit 5b monitors the operation state of the secondary-data extraction processing unit 5a that is responsible for handling “fuel” data with a higher priority than “parking” data handled by the unit 5b, to determine whether or not the secondary-data extraction processing unit 5a is in operation for data extraction processing (Step ST1b). When the secondary-data extraction processing unit 5a is in operation (Step ST1b; “YES”), the secondary-data extraction processing unit 5b waits for a preset time period (for example, 10 seconds) (Step ST2b), and then returns its process to Step ST1b to repeat the process aforementioned.

In contrast, when the secondary-data extraction processing unit 5a is not in operation (Step ST1b; “NO”), the secondary-data extraction processing unit 5b accepts inputs on the host-vehicle position detected by the host-vehicle position detection unit 10, extracts from the “parking” data in the primary database stored in the primary database storing unit 4b a predetermined number of data determined to be relating to the area around the host-vehicle position, and registers these data in the secondary database in the secondary database storing unit 6b (Step ST3b).

It is noted that the “parking” data determined to be related to the area around the host-vehicle position are the data which parking places near the host-vehicle position are associated with. Determination on whether or not a parking place is near the host-vehicle position is made by first calculating a difference in distance between the position of the parking place (latitude and longitude) and the current host-vehicle position (latitude and longitude) detected by the host-vehicle position detection unit 10 and then comparing the difference in distance to a predetermined threshold value.

Then, based on a travel distance of the host vehicle detected by the travel distance detection unit 9, the secondary-data extraction processing unit 5b determines whether or not the host vehicle has run a predetermined distance (for example, 2 km) from the time point when the data were extracted from the primary database and stored in the secondary database previously (Step ST4b). When it is determined that the host vehicle has run the predetermined distance (Step ST4b; “YES”), the secondary-data extraction processing unit 5b returns its process to Step ST1b to retrieve from the primary database a predetermined number of “parking” data (for example, 50 data) of the parking places near the host-vehicle position at that time, and stores the retrieved data in the secondary database.

When it is determined that the host vehicle has not run the predetermined distance (Step ST4b; “NO”), the secondary-data extraction processing unit 5b waits for a preset time period (for example, 10 seconds) (Step ST5b), and then returns its process to Step ST4b to repeat the process aforementioned. As a result, every time the host vehicle has traveled 2 kilometers, the data content in the secondary database are updated and the data related to the predetermined number of the parking places around the host vehicle are stored therein.

As shown in FIG. 6(c), the secondary-data extraction processing unit 5c monitors the operation states of both the secondary-data extraction processing units 5a and 5b that are responsible for handling “fuel” data and “parking” data respectively, each having a higher priority than “movie theater” data handled by the unit 5c, to determine whether or not the secondary-data extraction processing unit 5a or the secondary-data extraction processing unit 5b is in operation for data extraction processing (Step ST1c). When the secondary-data extraction processing unit 5a or the secondary-data extraction processing unit 5b is in operation (Step ST1c; “YES”), the secondary-data extraction processing unit 5c waits for a preset time period (for example, 10 seconds) (Step ST2c), and then returns its process to Step ST1c to repeat the process aforementioned.

When neither of the secondary-data extraction processing unit 5a nor the secondary-data extraction processing unit 5b is in operation (Step ST1c; “NO”), the secondary-data extraction processing unit 5c accepts inputs on the host-vehicle position detected by the host-vehicle position detection unit 10, extracts from the “movie theater” data in the primary database stored in the primary database storing unit 4c a predetermined number of data determined to be relating to the area around the host-vehicle position, and registers these data in the secondary database in the secondary database storing unit 6c (Step ST3c).

It is noted that the “movie theater” data determined to be related to the area around the host-vehicle position are the data which movie theaters near the host-vehicle position are associated with. Determination on whether or not a movie theater is near the host-vehicle position is made by first calculating a difference in distance between the position of the movie theater (latitude and longitude) and the current host-vehicle position (latitude and longitude) detected by the host-vehicle position detection unit 10 and then comparing the difference in distance to a predetermined threshold value.

Then, based on a travel distance of the host vehicle detected by the travel distance detection unit 9, the secondary-data extraction processing unit 5c determines whether or not the host vehicle has run a predetermined distance (for example, 2 km) from the time point when the data were extracted from the primary database and stored in the secondary database previously (Step ST4c). When it is determined that the host vehicle has run the predetermined distance (Step ST4c; “YES”), the secondary-data extraction processing unit 5c returns its process to Step ST1c to retrieve from the primary database a predetermined number of “movie theater” data (for example, 50 data) of the movie theaters near the host-vehicle position at that time, and stores the retrieved data in the secondary database.

In contrast, when it is determined that the host vehicle has not run the predetermined distance (Step ST4c; “NO”), the secondary-data extraction processing unit 5c waits for a preset time period (for example, 10 seconds) (Step ST5c), and then returns its process to Step ST4c to repeat the process aforementioned. As a result, every time the host vehicle has moved 2 kilometers, the data content in the secondary database are updated and the data related to the predetermined number of the movie theaters around the host vehicle are stored therein.

Upon receiving a data extraction request, each display-data extraction processing unit 7a-7c accesses the corresponding secondary database storing unit 6a-6c and sorts the data stored in the corresponding secondary database in order of distance from the current host-vehicle position detected by the host-vehicle detection unit 10, to extract a predetermined number of data (for example 10 data) with higher-order and closer distance from the corresponding secondary database. Then, the data extracted by each display-data extraction processing unit 7a-7c are outputted to display 8, whereby display 8 displays the data extracted by display-data extraction processing unit 7a-7c in the form of list.

As described above, according to this Embodiment 2, the primary database, the database update processing unit (3a-3c), the secondary-data extraction processing unit (5a-5c), the secondary database, and the display-data extraction processing unit (7a-7c), are provided for each kind of facilities provided by one or more data distribution services. To the secondary-data extraction processing units 5a-5c provided for the respective kinds of facilities, a priority is assigned corresponding to the kind of facilities. As for the secondary-data extraction processing units 5a-5c, while a secondary-data extraction processing unit having a priority higher than the priority of a secondary-data extraction processing unit concerned is carrying out data extraction from the corresponding primary database, the secondary-data extraction processing unit concerned does not extract the data from the corresponding primary database.

When several kinds of data acquired through one or more data distribution services are presented to the user, the above-described configuration improves the display response to data display requests, as is the case with Embodiment 1. Further, as for the secondary-data extraction processing units 5a to 5c, while a secondary-data extraction processing unit handling a higher priority data is in operation, the other(s) suspends its operation until the operations by the secondary-data extraction processing unit handling the higher priority data is completed. This avoids a situation where: the process load on the processor of a computer serving as the in-vehicle information presentation device 1A becomes too high because of congestion in operations of the secondary-data extraction processing units, processes are concentrated on reading out from storages storing the databases, and operation for processes other than the data distribution service are delayed.

In the above Embodiment 2, the case is described where the in-vehicle information presentation device 1A presents to the user the data related to the area around the host-vehicle position in the form of list; however, the way to present data is not limited thereto. Namely, it may be any ways in which the data extracted from the secondary database are presented. For example, the in-vehicle information presentation device 1A may display the data related only to the station, the parking place and the movie theater that are nearest to the host-vehicle position, while providing an audio assist therefor.

### Embodiment 3

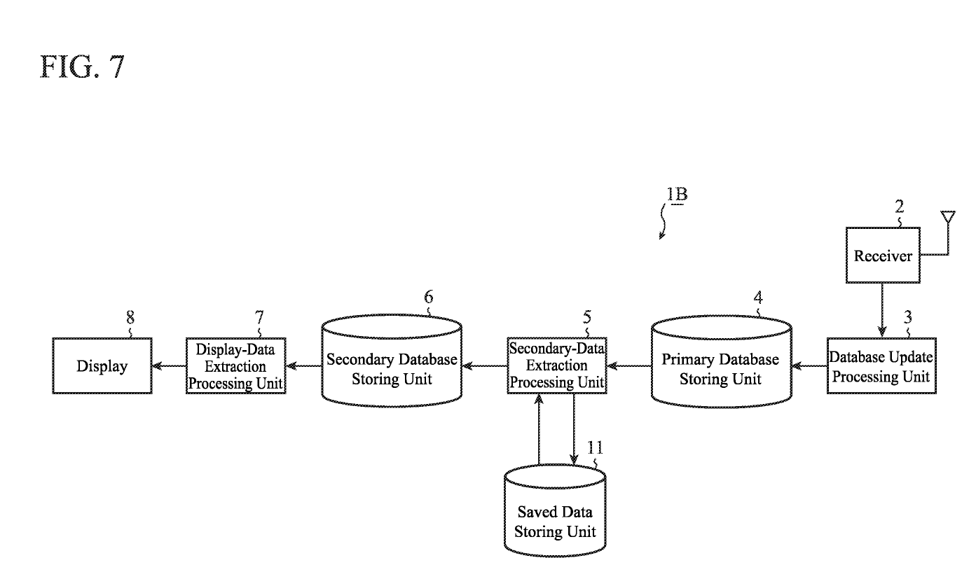

FIG. 7 is a block diagram showing a configuration of an in-vehicle information presentation device according to Embodiment 3 of the invention. In FIG. 7, the in-vehicle information presentation device 1B includes a receiver 2, a database update processing unit 3, a primary database storing unit 4, a secondary-data extraction processing unit 5, a secondary database storing unit 6, a display-data extraction processing unit 7, a display 8, and a saved data storing unit 11. It is noted that, in FIG. 7, a travel distance detection unit 9, a host-vehicle position detection unit 10 and a GPS receiver 10a are omitted from the illustration. Further, in FIG. 7, the same reference numerals are used to indicate the same units as those in FIG. 1, so that redundant illustrations are omitted here.

When applying the in-vehicle information presentation device according to Embodiment 1 to an actual product, a quickly accessible volatile memory such as a DRAM (Dynamic Random Access Memory) or the like will be used as the secondary database storing unit 6 in order to quickly display, for example, a station list in response to a display request.

This is because the DRAM can be accessed much more quickly than a hard disk drive (HDD) device.

According to such a volatile memory, however, the content in the secondary database on the memory are erased when the power is turned off (ACC OFF). In this instance, the secondary database is in a state of having no content at the time of next power-on (ACC ON), so that it is impossible to display, for example, a station list until completion of secondary data extraction process after power-on.

Recently, a memory medium which is non-volatile and accessible as quick as a conventional memory has been put to practical use; however, it is expensive, so that using such a memory medium leads to a rise in the product price.

Accordingly, in Embodiment 3, while the secondary database storing unit 6 is configured with a quickly accessible volatile memory, as shown in FIG. 7, there is provided a saved data storing unit 11 configured with a non-volatile memory. The content of the secondary database in the secondary database storing unit 6 are saved in the saved data storing unit 11 at the time of power-off. Then, when the power is turned on, the content of the secondary database in the secondary database storing unit 6 are restored from the saved data storing unit 11. This makes it possible to quickly display, for example, a station list without using an expensive quickly-accessible non-volatile memory. Note that the saved data storing unit 11 may be any non-volatile memories. For example, a part of the storage area in a HDD where the primary database storing unit 4 is implemented may be used as the saved data storing unit 11. Also, a USB (Universal Serial Bus) memory or the like may be used.

Next, the operation will be described.

Here, a data extraction process by the secondary-data extraction processing unit 5 is described in accordance with a case of receiving data distribution services related to fuel stations. Further, for the processes described hereinafter, it is assumed that the database update processing units 3 updates the primary database stored in the primary database storing unit 4 using the data received by the receiver 2. Also, it is assumed that the secondary-data extraction processing unit 5 accepts inputs on the host-vehicle position detected by the host-vehicle position detection unit 10, extracts from the data of the primary database stored in the primary database storing unit 4 a predetermined number of data related to the stations located around the host-vehicle position, and registers the extracted data in the secondary database stored in the secondary database storing unit 6.

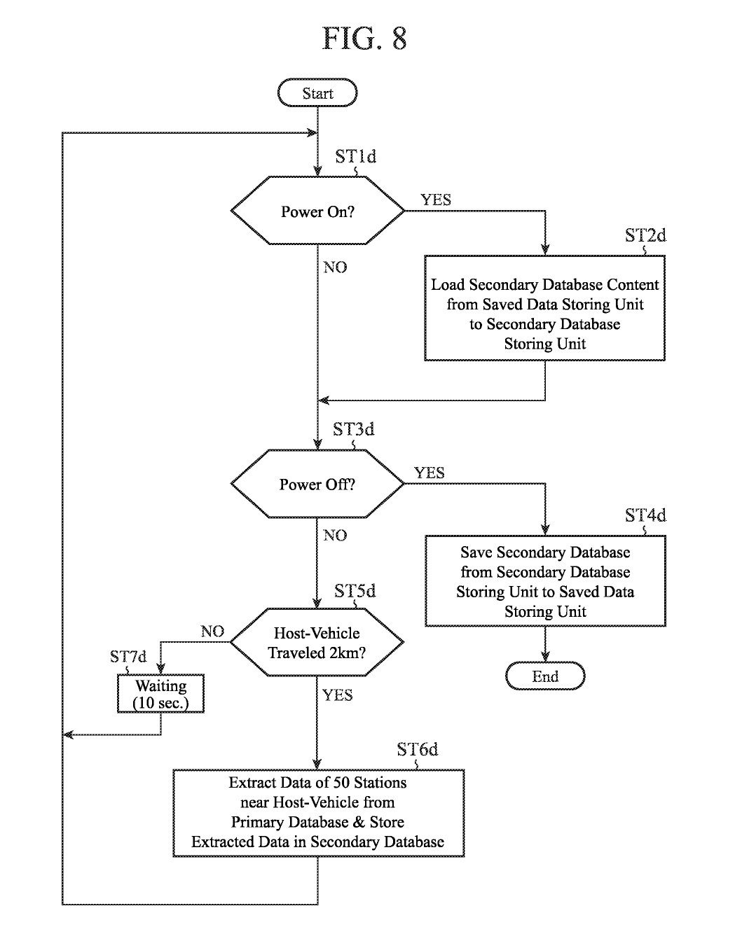

FIG. 8 is a flowchart showing the secondary-data extraction process in Embodiment 3.

Firstly, when the on-vehicle information presentation device 1B is powered-on (Step ST1d; “YES”), the secondary-data extraction processing unit 5 loads the content of the secondary database from the saved data storing unit 11 into the secondary database storing unit (Step ST2d).

In contrast, when no power-on operation is made for the on-vehicle information presentation device 1B (Step Slid; “NO”) and a power-off operation for the on-vehicle information presentation device 1B is made (Step ST3d; “YES”), the secondary-data extraction processing unit 5 reads out, before the power of the in-vehicle information presentation device 1B is turned off, the content of the secondary database from the secondary database storing unit 6 to save(store) the read-out data in the saved data storing unit 11 (Step ST4d). Then, the power of the in-vehicle information presentation device 1B is turned off, and the process ends.

When no power-off operation is made for the in-vehicle information presentation device 1B (Step ST3d; “NO”), the secondary-data extraction processing unit 5 determines whether or not the host vehicle has run a predetermined distance (for example, 2 km) from the time point when the data were extracted from the primary database and stored in the secondary database previously (Step ST5d).

When it is determined that the host vehicle has run the predetermined distance (Step ST5d; “YES”), the secondary-data extraction processing unit 5 accepts inputs on the host-vehicle position at that time detected by the host-vehicle position detection unit 10, extracts from the data of the primary database stored in the primary database storing unit 4 a predetermined number of data (for example, 50 data) related to the stations around the host-vehicle position, and registers these data in the secondary database in the secondary database storing unit 6 (Step ST6d). Thereafter, the flow returns to the process in Step ST1d.

When it is determined that the host vehicle has not run the predetermined distance (Step ST5d; “NO”), the secondary-data extraction processing unit 5 waits for a preset time period (for example, 10 seconds) (Step ST7d), and then returns its process to Step ST1d to repeat the process aforementioned.

As described above, according to Embodiment 3, it includes the saved data storing unit 11 for saving the content of the secondary database, allowing the secondary-data extraction processing unit 5 to restore the secondary database with the content saved in the saved data storing unit 11 when the content of the secondary database storing unit 6 was erased. Thus, even if the secondary database is implemented with a volatile memory, the secondary database containing data extracted from the primary database is constructed in the secondary database storing unit 6 immediately after the device 1B is powered on. This achieves an effect similar to that of the above Embodiment 1 from just after the power-on of the device 1B. Namely, it becomes possible to quickly display, for example, a station list from just after the power-on of the device 1B.

### Embodiment 4

In this Embodiment 4, a configuration of a navigation device to which an in-vehicle information presentation device of the present invention is applied will be described.

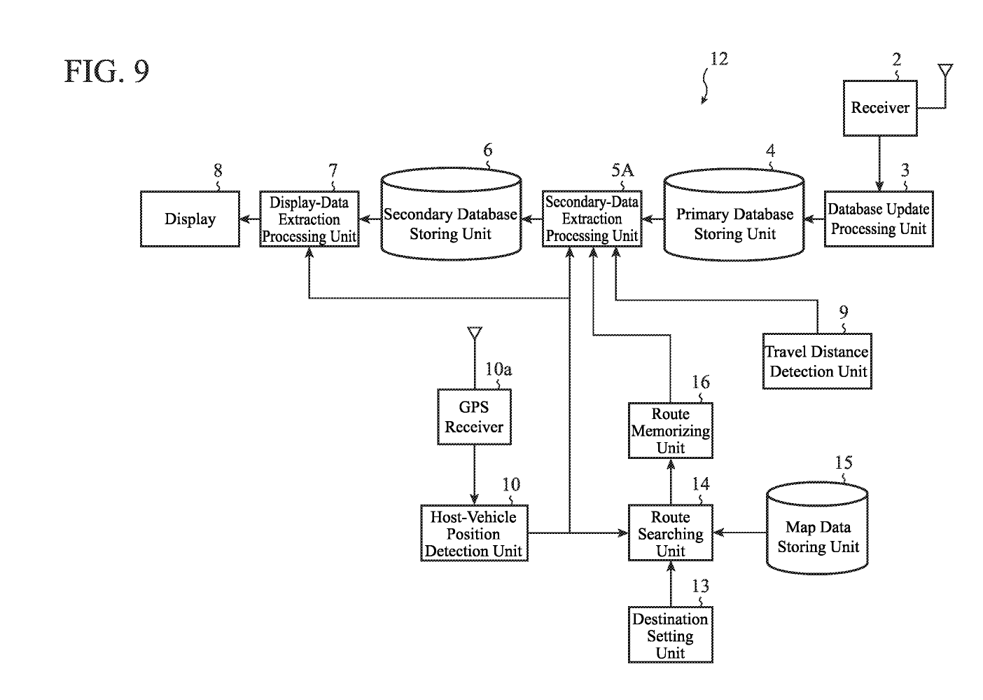

FIG. 9 is a block diagram showing the configuration of such a navigation device according to Embodiment 4 according to the present invention. In FIG. 9, the navigation device 12 according to Embodiment 4 includes a receiver 2, a database update processing unit 3, a primary database storing unit 4, a secondary-data extraction processing unit 5A, a secondary database storing unit 6, a display-data extraction processing unit 7, a display 8, a travel distance detection unit 9, a host-vehicle position detection unit 10, a GPS receiver 10a, a destination setting unit 13, a route searching unit 14, a map data storing unit 15, and a route memorizing unit 16. Note that, in FIG. 9, the same reference numerals are used to indicate the same units as those in FIG. 1, so that redundant illustrations are omitted here.

When there is no guide route searched by the route searching unit 14, the secondary-data extraction processing unit 5A, as is the case with Embodiment 1, extracts from the primary database, every time the host vehicle is detected to have traveled a predetermined distance a predetermined number of data related to the area around the host-vehicle position detected by the host-vehicle position detection unit 10, to store these extracted data in the secondary database.

In contrast, when there is a guide route searched by the route searching unit 14, the secondary-data extraction processing unit 5A extracts from the primary database a predetermined number of data related to the area located along the guide route, to store the extracted data in the secondary database. For example, in the case of receiving data distribution services related to fuel stations, such as a gas station, the data related to the stations located along the guide route which is searched by the route searching unit 14 are extracted and stored in the secondary database.

The destination setting unit 13 is an input unit for setting a destination used for a route calculation, and is implemented with an operation-key button, a touch panel provided on the display 8, a remote-control switch or the like. The route searching unit 14 is a configuration unit for searching a guide route to the destination based on a host-vehicle position detected by the host-vehicle position detection unit 10, a destination set by the destination setting unit 13 and map data acquired from the map data storing unit 15. The map data storing unit 15 is a storing unit for memorizing map data used for a navigation process including, but not limited to, route searching, route guidance, and map displaying. The route memorizing unit 16 memorizes information related to the guide route searched by the route searching unit 14. Note that the term “the information related to the guide route” means map data or the like related to the guide route. For example, it includes position coordinates of a departure point and a destination (latitudes and longitudes), road links constituting the route, and the like.

Next, the operation will be described.

Here, a data extraction process by the secondary-data extraction processing unit 5A is described in accordance with a case of receiving data distribution services related to fuel stations. Further, for the processes described hereinafter, it is assumed that the database update processing units 3 updates the primary database stored in the primary database storing unit 4 using the data received by the receiver 2.

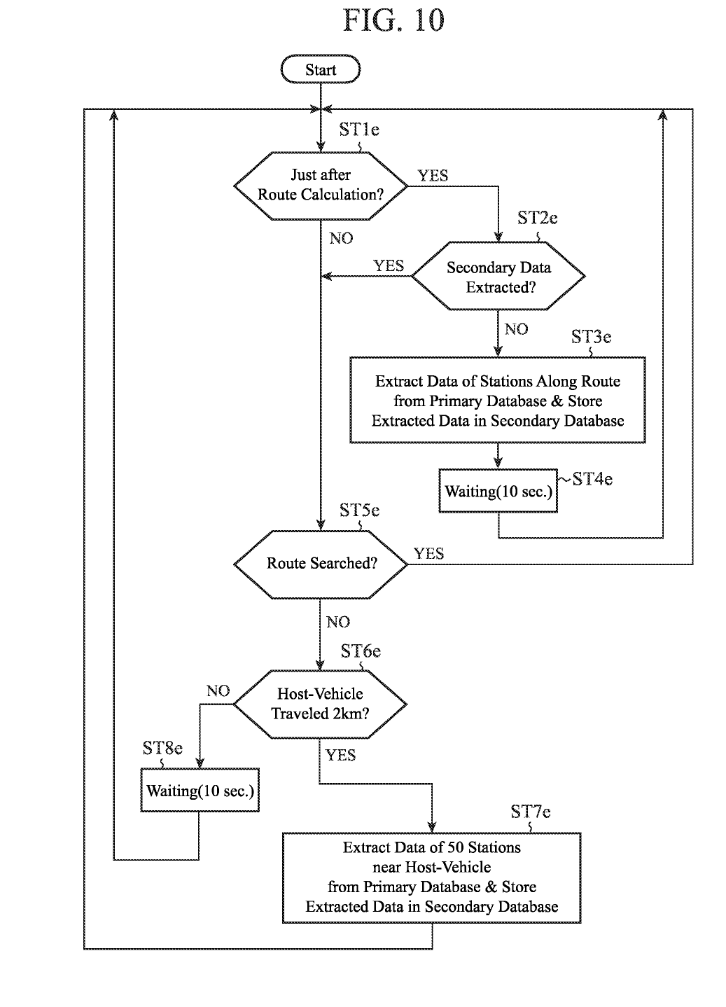

FIG. 10 is a flowchart showing a secondary-data extraction process in Embodiment 4. Firstly, the secondary-data extraction processing unit 5A always monitors the content of the route memorizing unit 16 to determine whether or not it is just after the route searching unit 14 has calculated a route (Step ST1e).

If it is just after the content of the route memorizing unit 16 is updated, that is, it is just after the route searching unit 14 has calculated a route (Step ST1e; “YES”), then the secondary-data extraction processing unit 5A determines whether or not the secondary data have been extracted into the secondary database (Step ST2e).

If the secondary data has not extracted into the secondary database (Step ST2e; “NO”), the secondary-data extraction processing unit 5A extracts based on information related to the guide route acquired from the route memorizing unit 16, the data related to the stations located along (near) the guide route from the primary database, to store them in the secondary database (Step ST3e). Subsequently, the secondary-data extraction processing unit 5A waits for a preset time period (for example, 10 seconds) (Step ST4e), and then returns its process to Step ST1e to repeat the process aforementioned.

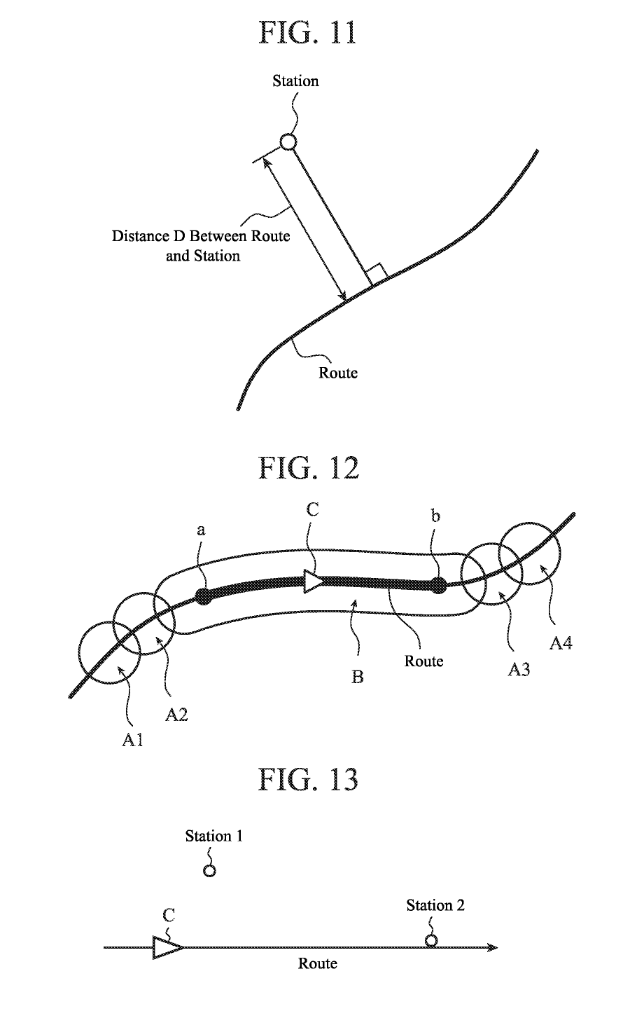

FIG. 11 is a diagram showing a definition of a distance between a route and a station. As shown in FIG. 11, the distance D between the route and the station is defined as the length of a line segment perpendicularly drawn from the position of a station (latitude and longitude) to a link of the route. In Step ST3e, the secondary-data extraction processing unit 5A determines that stations having a distance D within a predetermined threshold value are located along (near) the route. Note that the distance D can be calculated based on the position information on road links in the map data and the position information on stations (latitude and longitude).

If it is not just after the route searching unit 14 has calculated a route (Step ST1e; “NO”), or if the secondary data have been already extracted (Step ST2e; “YES”), then the secondary-data extraction processing unit 5A monitors the content in the route memorizing unit 16 to determine whether or not there is a guide route already searched by the route searching unit 14 (Step ST5e). If there is a guide route already searched by the route searching unit 14 (Step ST5e; “YES”), the secondary-data extraction unit 5A returns it process to Step ST1e to repeat the process aforementioned.

If there is no guide route searched by the route searching unit 14 (Step ST5e; “NO”), the secondary-data extraction processing unit 5A determines, based on a travel distance of the host vehicle detected by the travel distance detection unit 9, whether or not the host vehicle has run a predetermined distance (for example, 2 km) from the time point when the data were extracted from the primary database and stored in the secondary database previously (Step ST6e).

When it is determined that the host vehicle has run the predetermined distance (Step ST6e; “YES”), the secondary-data extraction processing unit 5A accepts inputs on the current host-vehicle position detected by the host-vehicle position detection unit 10, extracts from the data of the primary database stored in the primary database storing unit 4 a predetermined number of data (for example, 50 data) related to the stations located around the host-vehicle position, and registers them in the secondary database in the secondary database storing unit 6 (Step ST7e). Thereafter, the flow returns to the process at Step ST1e.

When it is determined that the host vehicle has not run the predetermined distance (Step ST6e; “NO”), the secondary-data extraction processing unit 5A waits for a preset time period (for example, 10 seconds) (Step ST8e), and then returns to the process at Step ST1e to repeat the process aforementioned.

FIG. 12 is a diagram showing schematically an extraction area of secondary data by the navigation device of Embodiment 4. In FIG. 12, a case is illustrated where the user sets a position “b” as a destination using the destination setting unit 13 when the host vehicle C reaches a position “a”, so that the route from the position “a” to the position “b” is calculated by the route searching unit 14. Namely, the navigation device 12 guides a route while the host vehicle C is running from the position “a” to the position “b”.

In areas A1 and A2 shown in FIG. 12, the navigation device 12 does not guide a route, but performs the processes of Steps ST6e-ST8e to extract from the primary database a predetermined number of data (for example, 50 data) related to the stations near the host-vehicle position every time the host vehicle C has run a predetermined distance (for example, 2 km). These extracted data are stored in the secondary database

When the host vehicle C reaches the position “a”, the user sets the position “b” as a destination using the destination setting unit 13, so that the route from the position “a” to the position “b” is calculated by the route searching unit 14.

Just after the route searching unit 14 has calculated a route, the secondary-data extraction processing unit 5A extracts from the primary database a predetermined number of data (for example, 200 data) related to the stations located along (near) the guide route, to store them in the secondary database. Here, the distances D between the respective stations and the route are calculated, and 200 number of data related to the stations are extracted, for example, in ascending order of the distances D (shortest to longest).

After extracting the data related to the stations located along (near) the route as described above, until the host vehicle C passes the position “b” as the destination, the secondary-data extraction processing unit 5A does not perform the processing of extracting the station-related data from the primary database to store them in the secondary database

When the host vehicle C runs in an area A3 or A4 passing through the destination (position “b”), the host vehicle C is under the condition again where no guide route is provided. Therefore, the secondary-data extraction processing unit 5A extracts from the primary database a predetermined number of data (for example, 50 data) related to the stations near the host-vehicle position every time the host vehicle C has run a predetermined distance (for example, 2 km).

It is noted that the number of data related to the stations near the route to be extracted after the route calculation (for example, 200 data) may be varied depending on the length of a route (travel distance). For example, the number may be calculated in proportion to the travel distance according to the following formula: (a constant number (for example 30 data) per unit-distance) (number/km)*(travel distance) (km).

FIG. 13 is a diagram for illustrating a benefit of extracting the station-related data near the route. When a destination has already been set and thus a guide route calculated, the navigation device 12 extracts in advance the data related to the stations located along the route. The navigation device 12 display a station list drawn up from among the extracted ones. This allows a well-suited station list to be presented.

For example, when the host vehicle C is at the position on the route shown in FIG. 13, the station 1 is nearer to the host-vehicle position than the station 2. However, the station 1 is distant from the route, and thus when visiting this station the vehicle needs to turn off the route to large extent.

On the contrary, if focusing on the distance from the route, the station 2 is determined to be nearer than the station 1. Namely, when visiting the station 2 the vehicle only needs to turn off the route to small extent. Thus, by extracting the data located along (near) the route, the secondary database can be created with the data of the stations less distant from the route.

As described above, according to Embodiment 4, it includes: the receiver 2 for receiving broadcasts related to a data distribution service from a broadcast station, to acquire data related to facilities as information service objects by the data distribution service; the primary database storing unit 4 for storing a primary database in which the data acquired by the receiver 2 are recorded; the database update processing unit 3 for updating contents of the primary database at every time the receiver 2 acquires the data using this data acquired by the receiver 2; the host-vehicle position detection unit 10 for detecting a position of a host vehicle; the destination setting unit 13 for setting a destination of the host vehicle; the route searching unit 14 for searching a guide route for the host vehicle using the position of the host vehicle detected by the host-vehicle position detection unit 10, the destination set by the destination setting unit 13 and map data acquired by the map data storing unit 15; the secondary-data extraction processing unit 5A for extracting from the primary database, the data related to facilities near the guide route searched by the route searching unit 14; the secondary database storing unit 6 for storing a secondary database in which the data extracted by the secondary-data extraction processing unit 5A are recorded; the display-data extraction processing unit 7 for extracting data for display from the data recorded in the secondary database; and the display 8 for displaying the data extracted by the display-data extraction processing unit 7 to present them to a user.

Thus, from among the data registered in the primary database, data related to the facilities located along (near) the guide route are extracted in advance and registered in the secondary database, and the data extracted from the secondary database are displayed when a data display request is made. This improves the display response to data display requests. That is, the display response time before actually displaying the requested data is shortened.

Further, in a period from just after the completion of the route calculation until the arrival at the destination, since the secondary-data extraction processing unit 5A performs an extraction of the data related to the facilities located along (near) the guide route, the number of times of accessing the primary database storing unit 4 to extract the secondary data is just one. Thus, the calculation process by the secondary-data extraction unit 5A is unnecessary while the host vehicle C runs on the route, resulting in reduction of calculation loads in the readout process by the processor from the HDD.

Furthermore, according to Embodiment 4, when a guide route has not been searched by the route searching unit 14, the secondary-data extraction processing unit 5A extracts from the primary database the data related to the facilities located around the host-vehicle position detected by the host-vehicle position detection unit 10 at that time every time the host vehicle C is detected to have run a predetermined distance, so that an effect similar to that in the above Embodiment 1 is provided even in a period when the route searching unit 14 does not calculate a route.

It is noted that by applying a concept of previously mentioned Embodiment 2 or Embodiment 3 to the navigation device of the above Embodiment 4, the same effect as in Embodiment 2 or Embodiment 3 is provided.

In the above Embodiment 4, although the case is described where the information presentation device of the present invention is applied to a navigation device for in-vehicle use, the information presentation device may be applied not only to a navigation device for in-vehicle use, but also to a mobile phone terminal or a personal digital assistance (PDA).

Also, it may be applied to a portable navigation device (PND) or the like that is carried by a person and used in a vehicle, a train, a ship, an airplane or the like.

### Embodiment 5

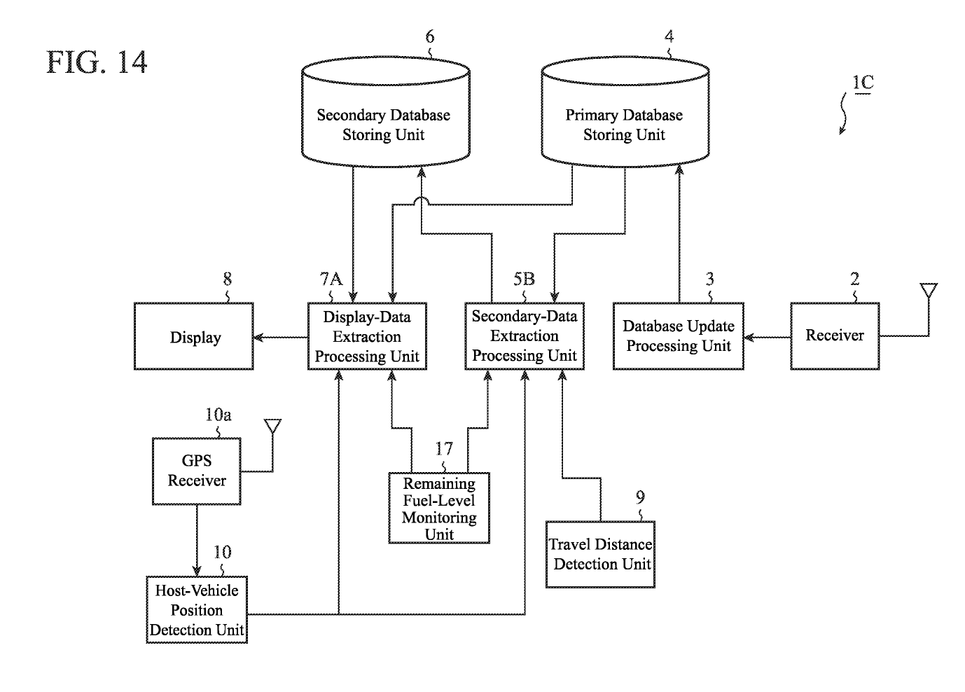

FIG. 14 a block diagram showing a configuration of an in-vehicle information presentation device according to Embodiment 5 of the present invention. In FIG. 14, the in-vehicle information presentation device 1C of Embodiment 5 includes a receiver 2, a database update processing unit 3, a primary database storing unit 4, a secondary-data extraction processing unit 5B, a secondary database storing unit 6, a display-data extraction processing unit 7A, a display 8, a travel distance detection unit 9, a host-vehicle position detection unit 10, a GPS receiver 10a, and a remaining fuel-level monitoring unit 17. Further, in FIG. 14, the same reference numerals are used to indicate the same units as those in FIG. 1, so that redundant illustrations are omitted here.

When the remaining fuel level of the host vehicle becomes a predetermined value or less, the secondary-data extraction processing unit 5B extracts from the primary database a predetermined number of data related to the area around the host-vehicle position detected by the host-vehicle position detection unit 10 every time the travel distance detection unit 9 detects that the host vehicle has run a predetermined distance. The extracted data are stored in the secondary database.

The display-data extraction processing unit 7A sorts, depending on the remaining fuel level of the host vehicle, the data related to the area around the host-vehicle position stored in the primary database or the secondary database in order of distance from the host-vehicle position to extract a predetermined number of high-order data from the primary database or the secondary database.

The remaining fuel-level monitoring unit 17 monitors the remaining fuel level of the host vehicle and compares values of the remaining fuel level to a predetermined value (threshold value) regarding the remaining fuel level. For example, it is monitored whether or not the remaining fuel level of the host vehicle is the predetermined value (threshold value) or less, and the monitoring result is output to the secondary-data extraction processing unit 5B and the display-data extraction processing unit 7A. Note that the remaining fuel-level monitoring unit 17 is provided in an electronic control unit (ECU) of the vehicle, and when the vehicle is an electric car, monitors the remaining capacity level of a rechargeable battery.

Next, the operation will be described.

(1) Update Process of Secondary Database

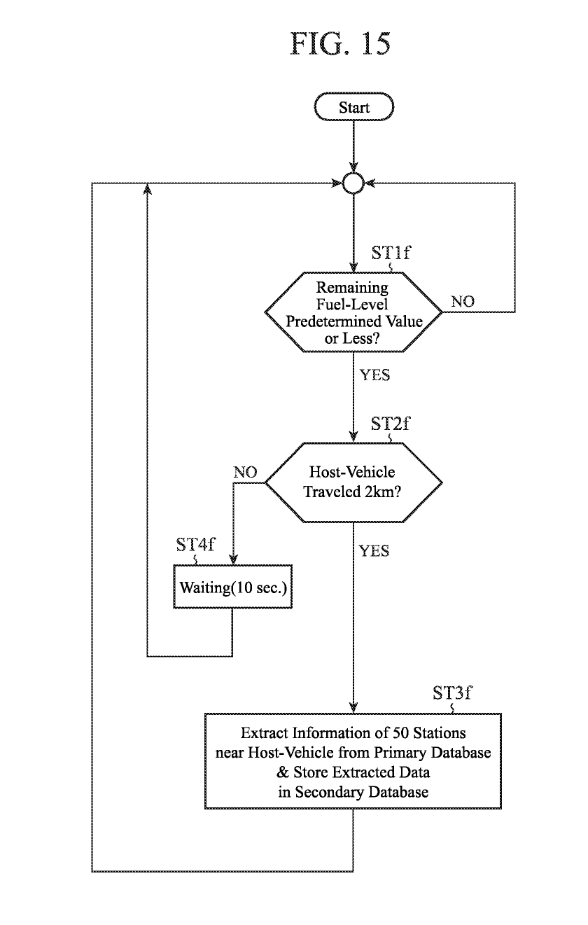

FIG. 15 is a flowchart showing a secondary-data extraction process in Embodiment 5.

Firstly, with reference to FIG. 15, a data extraction process by the secondary-data extraction processing unit 5B is described in accordance with a case of receiving data distribution services related to fuel stations. Further, for the processes described later, it is assumed that the database update processing units 3 updates the primary database stored in the primary database storing unit 4 using the data received by the receiver 2.

The remaining fuel-level monitoring unit 17 always monitors the remaining fuel level of the host vehicle to determine whether or not the remaining fuel level is the predetermined value or less (Step ST1f). When the remaining fuel level is more than the predetermined value (Step ST1f; “NO”), the process at Step 1f is repeated.

When the remaining fuel level is the predetermined value or less (Step ST1f; “YES”), the secondary-data extraction processing unit 5B determines, based on a travel distance of the host vehicle detected by the travel distance detection unit 9, whether or not the host vehicle has run a predetermined distance (for example, 2 km) from the time point when the data extracted from the primary database and stored in the secondary database previously (Step ST2f).

When it is determined that the host vehicle has run the predetermined distance (Step ST2f; “YES”), the secondary-data extraction processing unit 5B accepts inputs on the current host-vehicle position detected by the host-vehicle position detection unit 10, extracts from the data in the primary database stored in the primary database storing unit 4 a predetermined number of data (for example, 50 data) related to the stations located around the host-vehicle position, and registers them in the secondary database in the secondary database storing unit 6 (Step ST3f). Thereafter, the flow returns to the process at Step ST1f.

When it is determined that the host vehicle has not run the predetermined distance (Step ST2f; “NO”), the secondary-data extraction processing unit 5B waits for a preset time period (for example, 10 seconds) (Step ST4f), and then returns to the process at Step ST1f to repeat the processes aforementioned.

It is considered that the time when the user receiving the data distribution services on fuel stations refers to the station list is when the user feels the necessity for fueling the host vehicle. From this point of view, in Embodiment 5, the secondary data extraction process is performed only when the remaining fuel level of the host vehicle is the predetermined value or less. This improves the display response to station list display requests when there are high possibilities that the user refers to the station list. Further, when the remaining fuel level of the host vehicle is more than the predetermined value and therefore the user is less likely to refer to the station list, the calculation process by the secondary-data extraction processing unit 5B becomes unnecessary, resulting in reduction of calculation loads in the readout process by the processor from the HDD.

(2) Presentation Process of Service Data

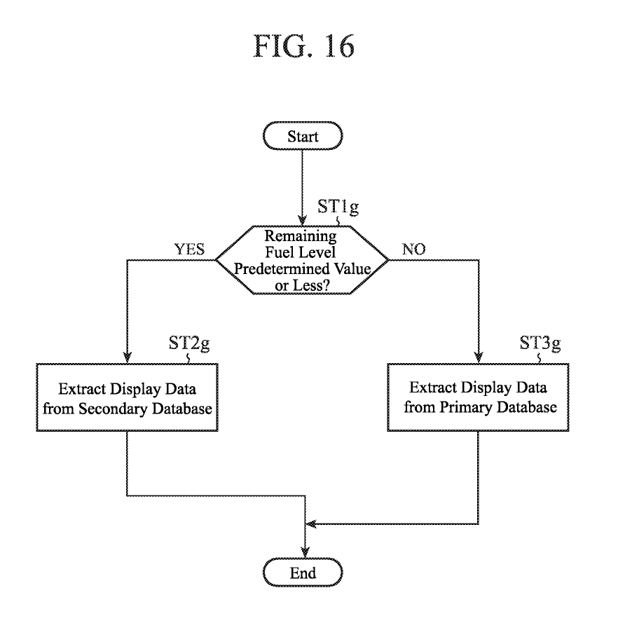

FIG. 16 is a flowchart showing a display-data extraction process in Embodiment 5. With reference to FIG. 16, the display-data extraction process by the display-data extraction unit 7A, that is, the presentation process of the service data, will be described in accordance with a case of receiving the data distribution services related to fuel stations.

Firstly, the remaining fuel-level monitoring unit 17 always monitors the remaining fuel level of the host vehicle to determine whether or not the remaining fuel level is the predetermined value or less (Step ST1g).

When the remaining fuel level of the host vehicle is the predetermined value or less (Step ST1g; “YES”), the display-data extraction processing unit 7A accesses, upon receiving a data extraction request associated with a list display request by the user, the secondary database storing unit 6 and sorts the data stored in the secondary database in order of distance from the current host-vehicle position detected by the host-vehicle detection unit 10, to extract a predetermined number of data (for example 10 data) with higher-order and closer distance from the secondary database (Step ST2g). The data extracted by the display-data extraction processing unit 7A are displayed in station list on the display 8.

In contrast, when the remaining fuel-level of the host vehicle is more than the predetermined value (Step ST1g; “NO”), the display-data extraction processing unit 7A accesses, upon receiving a data extraction request associated with a list display request, the primary database storing unit 4 and sorts the data stored in the primary database in order of distance from the current host-vehicle position detected by the host-vehicle detection unit 10, to extract a predetermined number of data (for example 10 data) with higher-order and closer distance from the primary database (Step ST3g). As is the case mentioned in the above, the data extracted by the display-data extraction processing unit 7A are displayed in a station list on the display 8.

As to the presentation process of the service data, by selecting whether to extract the display data from the secondary database or to extract the display data from the primary database depending on the condition of the vehicle (for example, remaining fuel level) as described above, access concentration and readout loads on the secondary database storing unit 6 can be reduced.

As described above, according to Embodiment 5. It includes the remaining fuel-level monitoring unit 17 for monitoring a remaining fuel-level, wherein in the primary database storing unit 4, the primary data base are stored in which the data related to fuel-supplying stations acquired by the receiver 2 are registered; and the secondary-data extraction processing unit 5B, when the remaining fuel-level monitoring unit 17 determines that the remaining fuel-level is a predetermined threshold value or less, performs extraction of data from the primary database, but, when the remaining fuel-level monitoring unit 17 determines that the remaining fuel-level is more than the predetermined threshold value, does not perform extraction of data from the primary database.

This improves the display response to station list display requests when there are high possibilities that the user refers to the station list. Further, since the secondary-data extracting operation is controlled according to the remaining fuel-level of the vehicle, it is possible to reduce the loads in the readout process by the processor from the HDD.

Furthermore, according to this Embodiment 5, the display-data extraction processing unit 7A, when the remaining fuel-level monitoring unit 17 determines that the remaining fuel-level is the predetermined threshold value or less, extracts the display data from the secondary database, and, when the remaining fuel-level monitoring unit 17 determines that the remaining fuel-level is more than the predetermined threshold value, extracts the display data from the primary database.

This prevents access concentration on the secondary database storing unit 6, thereby reducing the loads in calculation process and readout process by the processor in extracting the display-data.

### Embodiment 6

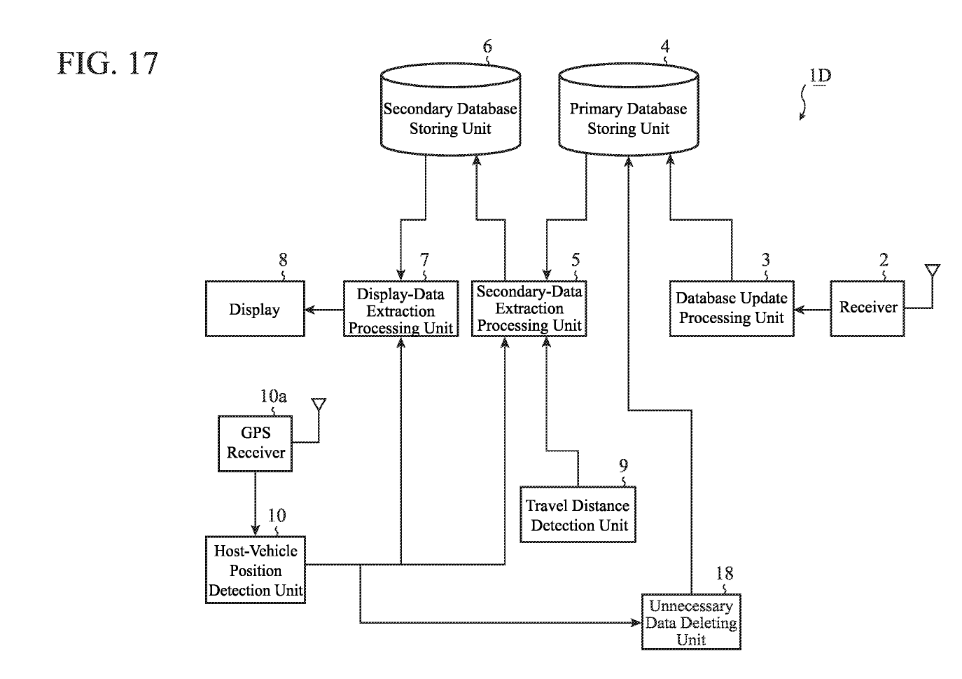

FIG. 17 is a block diagram showing a configuration of an in-vehicle information presentation device according to Embodiment 6 of this invention. As shown in FIG. 17, the in-vehicle information presentation device 1D includes a receiver 2, a database update processing unit 3, a primary database storing unit 4, a secondary-data extraction processing unit 5, a secondary database storing unit 6, a display-data extraction processing unit 7, a display 8, a travel distance detection unit 9, a host-vehicle position detection unit 10, a GPS receiver 10a, and an unnecessary data deleting unit 18. The unnecessary data deleting unit 18 identifies the data having become unnecessary in the primary database and deletes such identified unnecessary data. Further, in FIG. 17, the same reference numerals are used to indicate the same units as those in FIG. 1, so that redundant illustrations are omitted here.

Next, the operation will be described.

Here, an unnecessary data deleting process is described according to a case of receiving data distribution services related to fuel stations.

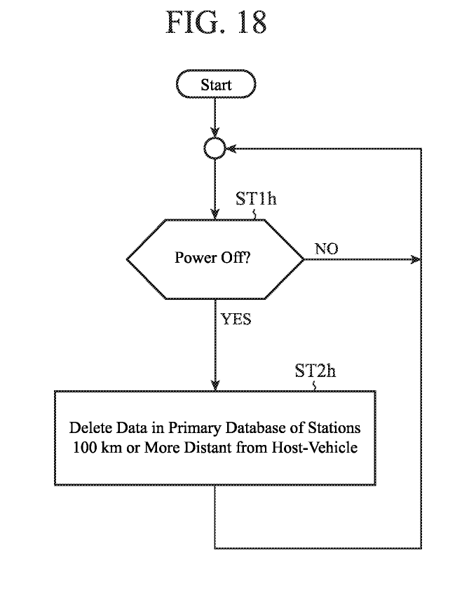

FIG. 18 is a flowchart showing the unnecessary data deleting process in Embodiment 6.

When a power-off operation (ACC OFF) of the in-vehicle information presentation device 1D is made (Step ST1h; “YES”), the unnecessary data deleting unit 18 accepts inputs on the host-vehicle position at that time from the host-vehicle position detection unit 10 and accesses the primary database storing unit 4 to delete data of the stations located distant from the host-vehicle position more than a predetermined distance (for example, 100 km) from the data stored in the primary database (Step ST2h).

In contrast, when no power-off (ACC OFF) operation of the in-vehicle information presentation device 1D is made (Step ST1h; “NO”), the unnecessary data deleting unit 18 returns to the process at Step ST1h to repeat the determination of power on/off operation.

Thus, by deleting the service data (for example, data related to stations) related to areas distant from the host-vehicle position more than a distance that the host-vehicle will probably not travel, for example, 100 km, the number of data in the primary database can be significantly decreased. This decreases the number of data processed in the secondary data extraction process, thereby reducing operation loads in readout processes by the processor from the HDD or the like in the secondary data extraction process.

Further, in the above Embodiment 6, the case is described where the unnecessary data are deleted from the primary database at the timing of the power-off operation of the in-vehicle information presentation device 1D; however, the timing or way to decrease the number of data processed in the secondary data extraction process is not limited thereto. For example, it may be the followings.

(A) The unnecessary data deleting unit 18 deletes unnecessary data from the primary database at the timing of power-on operation.

(B) Delete unnecessary data at the timing of the power on/off operation of the in-vehicle information presentation device 1D when the host vehicle has run a predetermined distance after unnecessary data were previously deleted. In this case, every time unnecessary data are deleted by the unnecessary data deleting unit 18, the travel distance detection unit 9 monitors the travel distance from that time and notifies it to the unnecessary data deleting unit 18. Alternatively, the determination of whether or not the host vehicle has run the predetermined distance may be based on the calculation of the difference between the host-vehicle position saved at the timing of deleting unnecessary data from the primary database and the current host-vehicle position.

(C) The unnecessary data deleting unit 18 deletes unnecessary data from the primary database at regular intervals (for example, once per day at a fixed clock time).

(D) Instead of providing the unnecessary data deleting unit 18, the database update processing unit 3 updates the content in the primary database using, for example, only the service data related to the area within a distance that the host vehicle may travel, which is determined based on inputs on the host-vehicle position from the host-vehicle position detection unit 10.

Further, described in the above Embodiment 6 is the case where the data related to stations located more than a predetermined distance (for example, 100 km) apart from the host-vehicle position are deleted as unnecessary data from the primary database; however, the way deleting data as being unnecessary data, which are excluded from the object to be processed by the secondary data extraction process, is not limited thereto. For example, the following methods may be applied.

(a) The unnecessary data deleting unit 18 calculates the time difference between the current time and the broadcast reception date of the service data concerned, and determines data received more than a predetermined time period (for example, one month) ago from now as unnecessary data to be deleted.

(b) The unnecessary data deleting unit 18 deletes the data specified by the user in advance.

(c) The unnecessary data deleting unit 18 deletes data that were not presented for more than a predetermined time period from now as display data on the display 8 to the user from the primary database.

As described above, according to Embodiment 6, it includes the unnecessary data deleting unit 18 for deleting unnecessary data from the primary database. In particular, the unnecessary data deleting unit 18 deletes, as unnecessary data from the primary database, the data related to facilities distant from the host-vehicle position detected by the host-vehicle position detection unit 10 by more than a predetermined distance. By deleting the service data like this, the volume (number) of data in the primary database is significantly reduced. This decreases the number of data processed in the secondary data extraction process, thereby reducing operation loads in readout processes by the processor from the HDD and the like in the secondary data extraction process.

Alternatively, the unnecessary data deleting unit 18 may be configured to delete, as unnecessary data from the primary database, data having a time difference of more than a predetermined value between the current time and the time when the broadcast was received by the receiver 2. This alternative configuration provides a similar effect to the above.

In Embodiments 1-6, description is made in accordance with a case where the data extracted from the secondary database are displayed to the user in the form of list on the display 8; however, the way to present the data is not limited thereto.

For example, the data extracted from the secondary database may be presented by sound using a sound output unit such as a speaker or the like. Also, a list display and an audio assist may be combined.

It should be noted that many combinations of the respective embodiments, modifications to any elements in the embodiments, and omission of optional elements from the embodiments may be made in the present invention without departing from the scope of the invention.

### INDUSTRIAL APPLICABILITY

The information presentation device according to the present invention is well-responsive to a request in making presentation of information stored in a database, and thus, it is preferable for an in-vehicle information device that successively presents information related to a destination of a vehicle, in particular, for a car-navigation device.

### DESCRIPTION OF REFERENCE NUMERALS AND SIGNS

1, 1A, 1B, 1C, 1D: in-vehicle information presentation device, 2: receiver, 3: database update processing unit, 4: primary database storing unit, 5, 5A, 5B: secondary-data extraction processing unit, 6: secondary database storing unit, 7, 7A: display-data extraction processing unit, 8: display, 9: travel distance detection unit, 10: host-vehicle position detection unit, 10a: GPS receiver, 11: saved data storing unit, 12: navigation device, 13: destination setting unit, 14: route searching unit, 15: map data storing unit, 16: route memorizing unit, 17: remaining fuel-level monitoring unit, 18: unnecessary data deleting unit.

1. An information presentation device to be installed in or carried by a movable entity, comprising:
a receiving unit for acquiring data related to facilities by receiving a broadcast providing a data distribution service from a broadcast station;
a primary database storing unit for storing a primary database in which the data acquired by the receiving unit are registered;
a database update processing unit for updating content in the primary database with data acquired by the receiving unit every time the receiving unit acquires data;
a travel distance detection unit for detecting that the movable entity has traveled a predetermined distance;
a position detection unit for detecting a position of the movable entity;
a secondary-data extraction processing unit for extracting, from the primary database, data related to facilities near the position of the movable entity detected by the position detection unit at each time point when the travel distance detection unit detects that the movable entity has traveled the predetermined distance;
a secondary database storing unit for storing a secondary database in which the data extracted by the secondary-data extraction processing unit are registered;
a presentation-data extraction processing unit for extracting data for presentation from the data registered in the secondary database; and
a presentation unit for presenting the data extracted by the presentation-data extraction processing unit to a user.

2. The information presentation device of claim 1, wherein the primary database, the database update processing unit, the secondary-data extraction processing unit, the secondary database, and the presentation-data extraction processing unit are provided for each kind of facilities provided by data distribution services,
each secondary-data extraction processing unit is assigned a priority corresponding to respective kind of facilities, and
the secondary-data extraction processing unit having a lower priority suspends extraction of data from the corresponding primary database while the secondary-data extraction processing unit having a higher priority is extracting data from the corresponding primary database.

3. The information presentation device of claim 1, further comprising a saved data storing unit for saving content of the secondary database, wherein the secondary-data extraction processing unit restores the secondary database with the content saved in the saved data storing unit in a case where the content in the secondary database storing unit has been erased.

4. The information presentation device of claim 1, wherein the movable entity is a vehicle, the information presentation device further comprising a remaining level monitoring unit for monitoring a remaining level of energy used to drive the vehicle, wherein
the primary data base stored in the primary database storing unit contains data related to energy-supplying facilities, the data being acquired through the receiving unit,
the secondary-data extraction processing unit extracts data from the primary database when the remaining level monitoring unit determines that the remaining level of energy is a predetermined threshold value or less, but does not extract data from the primary database when the remaining level monitoring unit determines that the remaining level of energy is more than the predetermined threshold value.

5. The information presentation device of claim 4, wherein the presentation-data extraction processing unit extracts the data for presentation from the secondary database when the remaining level monitoring unit determines that the remaining level of energy is the predetermined threshold value or less, but does not extract the data for presentation from the secondary database when the remaining level monitoring unit determines that the remaining level of energy is more than the predetermined threshold value.

6. The information presentation device of claim 1, further comprising an unnecessary data deleting unit for deleting unnecessary data from the primary database.

7. The information presentation device of claim 6, wherein the unnecessary data deleting unit deletes, as unnecessary data from the primary database, data related to a facility that is at a distance of a predetermined distance or more from the position of the movable entity detected by the position detection unit.

8. The information presentation device of claim 6, wherein the unnecessary data deleting unit deletes, as unnecessary data from the primary database, data that was received by the receiving unit more than a predetermined time before a current time.

9. A navigation device to be installed in or carried by a movable entity, comprising:
a receiving unit for acquiring data related to facilities by receiving a broadcast providing a data distribution service from a broadcast station;
a primary database storing unit for storing a primary database in which the data acquired by the receiving unit are recorded;
a database update processing unit for updating content in the primary database with data acquired by the receiving unit every time the receiving unit acquires data;
a position detection unit for detecting a position of the movable entity;
a destination setting unit for setting a destination of the movable entity;
a route searching unit for searching a guide route for the movable entity based on the position of the movable entity detected by the position detection unit, the destination set by the destination setting unit, and map data acquired from a map data storing unit;
a secondary-data extraction processing unit for extracting, from the primary database, data related to facilities located along the guide route searched by the route searching unit;
a secondary database storing unit for storing a secondary database in which the data extracted by the secondary-data extraction processing unit are registered;
a presentation-data extraction processing unit for extracting data for presentation from the data registered in the secondary database; and
a presentation unit for presenting the data extracted by the presentation-data extraction processing unit to a user.

10. The navigation device of claim 9, wherein the primary database, the database update processing unit, the secondary-data extraction processing unit, the secondary database, and the presentation-data extraction processing unit are provided for each kind of facilities provided by data distribution services,
each secondary-data extraction processing unit is assigned a priority corresponding to respective kind of facilities, and
the secondary-data extraction processing unit having a lower priority suspends extraction of data from the corresponding primary database while the secondary-data extraction processing unit having a higher priority is extracting data from the corresponding primary database.

11. The navigation device of claim 9, further comprising a saved data storing unit for saving content of the secondary database, wherein the secondary-data extraction processing unit restores the secondary database with the content saved in the saved data storing unit in a case where the content in the secondary database storing unit has been erased.

12. The navigation device of claim 9, further comprising a travel distance detection unit for detecting that the movable entity has traveled a predetermined distance, wherein the secondary-data extraction processing unit, while no guide route is searched by the route searching unit, extracts from the primary database data related to facilities near the position of the movable entity detected by the position detection unit at each time point when the travel distance detection unit detects that the movable entity has traveled the predetermined distance.
